(19) United States
(12) Patent Application Publication
(10) Pub. No.: US 2013/0177872 A1
(43) Pub. Date: Jul. 11, 2013

(54) CUSTOMIZABLE SCULPTABLE ANATOMICAL HEALING CAPS, SYSTEMS, AND RELATED METHODS

(71) Applicants: Mark H. Blaisdell, Bountiful, UT (US); Todd C. Liston, Ogden, UT (US)

(72) Inventors: Mark H. Blaisdell, Bountiful, UT (US); Todd C. Liston, Ogden, UT (US)

(21) Appl. No.: 13/347,127

(22) Filed: Jan. 10, 2012

(51) Int. Cl. A61C 8/00

(52) U.S. Cl. 433/173

(57) ABSTRACT

Customizable sculptable healing caps include a hollow elongate body extending between a proximal end and a distal end, as well as an enlarged cuff body extending laterally outward from the hollow elongate body. The cuff body includes a subgingival portion that is anatomically sized and shaped for providing substantially custom filling of the emergence portion of a void resulting from removal of a selected tooth. An exposed portion of the cuff body that resides gingivally above the subgingival portion may also be provided. At least the subgingival portion comprises a sculptable material (e.g., plastic or composite material) so that a practitioner can easily remove select portions with a burr, build up portions with application of a adhering dental material, or both to allow chair-side full customization so that the resulting subgingival portion fills the emergence portion of the void, better preserving the gingival features surrounding the site of tooth removal.

### BACKGROUND OF THE INVENTION

1. The Field of the Invention

This invention relates to healing caps or cuffs used in any stage of oral surgery where a tooth is extracted or missing, as well as related methods. Such an example of oral surgery includes first stage oral surgery, for example, when an implant is initially placed into a tooth void (e.g., whether the tooth is extracted or was congenitally or otherwise missing). The inventive healing caps or cuffs may also be used in any other dental surgery where it is desired to preserve the emergence profile of gingival tissue surrounding one or more teeth (e.g., second stage surgery, immediate or delayed implant placement, etc.).

2. Background and Relevant Art

In modern dentistry, when one or more teeth are removed it is desirable to eventually replace the tooth or teeth with a prosthesis (e.g., a crown, bridge, etc.), although this is typically accomplished weeks later. Once the tooth is removed or missing, a dental implant is placed into the bone tissue of the jaw to provide a secure foundation upon which a prosthesis can be supported. Typically, the site is allowed to heal for a period of time prior to installation of the permanent prosthesis. Currently, a device known as a healing cap, abutment, or cuff is coupled into the dental implant while the site is allowed to heal, to cap or cover the inside of the dental implant and to preserve the ability to re-access the dental implant once the site has sufficiently healed, when it is desired to install a prosthesis. Once the site has healed (e.g., typically 1.5 to 6 months after implant placement), the healing cap, abutment, or cuff is removed, and a custom prosthesis (e.g., a crown) may be installed, supported by the dental implant anchored within the jaw bone.

Existing dental healing caps, abutments, or cuffs, as well as the methods employed in their installation during immediate or subsequent dental placement and oral surgery exhibit several shortcomings.

### BRIEF SUMMARY

The present invention is directed to devices, systems, and methods for better preserving features of the gingival tissue that are characteristic surrounding a natural tooth. Such devices, systems, and methods are helpful in preserving or creating desired gingival tissue characteristics whether a tooth is extracted or is congenitally or otherwise missing. According to one embodiment, a chair-side customizable sculptable anatomical healing cap is provided. The sculptable anatomical healing cap includes a hollow elongate body extending between a proximal end and a distal dental implant insertion end. An enlarged cuff body extends laterally outward relative to the hollow elongate body, and is disposed between the proximal end and the distal end of the elongate body. The enlarged cuff body includes an asymmetrical cross-section and may also include an irregular surface which together are specifically configured to provide substantially custom filling of at least the emergence portion of the void (i.e., the gingival, upper portion of the void, adjacent to where the natural tooth once emerged from the void in the case of a tooth extraction or where a tooth would have emerged from the void in the case of a congenitally missing tooth).

In addition, the enlarged cuff body comprises a sculptable material such as plastic, composite or similar material (e.g., it is not formed of metal) so that a practitioner can easily remove select portions of the cuff body with a dental burr, add to the cuff body with a dental material (e.g., a curable composite), or both. This allows the practitioner to chair-side fully customize the cuff body so that it provides a customized fit that custom fills the emergence portion of the void.

Because the emergence portion of the various tooth positions are not identical to one another (but they do remain substantially the same from one person to another person when considering the same tooth position), different sculptable anatomical healing caps are provided for the various tooth positions, which differ in the particular configuration of the enlarged cuff body of the respective healing cap. For example, separately configured healing caps may typically be provided for the upper central incisors, the upper lateral incisors, the upper cuspids, the upper bicuspids, and the upper molars. A set of healing caps for the teeth of the lower dental arch may be similarly provided, e.g., lower incisors, lower cuspids, lower bicuspids, and lower molars. It may be possible to use identically configured healing caps for some teeth (e.g., first and second bicuspids, first and second molars, or all lower incisors.)

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an exemplary upper dental arch;

FIG. 1B is a perspective view of the dental arch of FIG. 1A in which a central incisor has been removed, leaving a void;

FIG. 1C is a perspective view of the dental arch of FIG. 1B in which a dental implant surgical drill is used to prepare an anchor hole in the underlying bone for anchoring a dental implant;

FIG. 1D is a perspective view of the arch of FIG. 1C as an implant is being inserted (e.g., with the aid of a transfer coping);

FIG. 1E is a perspective view of the arch and into the void showing the implant anchored into the bottom of the void;

FIG. 1F is a perspective view of the arch showing a state of the art healing cuff coupled into the implant;

FIG. 2A is an exploded perspective view of an exemplary sculptable anatomical healing cap according to the present invention including an enlarged cuff body having an asymmetrical cross-section and an irregular surface specifically configured for filling the emergence portion of the void formed when an upper central incisor is removed or is missing;

FIG. 2B is an assembled perspective view of the anatomical healing cap of FIG. 2A;

FIG. 2C is a side elevation view of the anatomical healing cap of FIG. 2B;

FIG. 2D is a top view of the anatomical healing cap of FIG. 2B;

FIG. 2E is a cross-sectional view through the anatomical healing cap of FIG. 2B;

FIG. 2F is a perspective view similar to that of FIG. 2B, but showing an alternative configuration at the distal dental implant end;

FIG. 2G is a perspective view similar to that of FIG. 2B, but showing another alternative configuration at the distal dental implant end;

FIG. 2H is a perspective view similar to that of FIG. 2B, but showing an alternative configuration including a removable grippable handle;

FIG. 3A is an exploded perspective view of an anatomical healing cap including a cuff body having an asymmetrical cross-section and irregular surface specifically configured for filling the emergence portion of the void formed when an upper lateral incisor is removed or missing;

FIG. 3B is an assembled perspective view of the anatomical healing cap of FIG. 3A;

FIG. 3C is a side elevation view of the anatomical healing cap of FIG. 3B;

FIG. 3D is a top view of the anatomical healing cap of FIG. 3B;

FIG. 3E is a cross-sectional view through the anatomical healing cap of FIG. 3B;

FIG. 4A is an exploded perspective view of an anatomical healing cap including a cuff body having an asymmetrical cross-section and irregular surface specifically configured for filling the emergence portion of the void formed when an upper cuspid is removed or missing;

FIG. 4B is an assembled perspective view of the anatomical healing cap of FIG. 4A;

FIG. 4C is a side elevation view of the anatomical healing cap of FIG. 4B;

FIG. 4D is a top view of the anatomical healing cap of FIG. 4B;

FIG. 4E is a cross-sectional view through the anatomical healing cap of FIG. 4B;

FIG. 5A is an exploded perspective view of an anatomical healing cap including a cuff body having an asymmetrical cross-section and irregular surface specifically configured for filling the emergence portion of the void formed when an upper bicuspid is removed or missing;

FIG. 5B is an assembled perspective view of the anatomical healing cap of FIG. 5A;

FIG. 5C is a side elevation view of the anatomical healing cap of FIG. 5B;

FIG. 5D is a top view of the anatomical healing cuff of FIG. 5B;

FIG. 5E is a cross-sectional view through the anatomical healing cap of FIG. 5B;

FIG. 6A is an exploded perspective view of an anatomical healing cap including a cuff body having an asymmetrical cross-section and irregular surface specifically configured for filling the emergence portion of the void formed when an upper molar is removed or missing;

FIG. 6B is an assembled perspective view of the anatomical healing cap of FIG. 6A;

FIG. 6C is a side elevation view of the anatomical healing cap of FIG. 6B;

FIG. 6D is a top view of the anatomical healing cap of FIG. 6B;

FIG. 6E is a cross-sectional view through the anatomical healing cap of FIG. 6B;

FIG. 7A is an exploded perspective view showing a related system including an anatomical healing cap and an associated temporary crown form;

FIG. 7B is a perspective view showing the system of FIG. 7A with the temporary crown form coupled over the anatomical healing cap with the crown form aligned with the healing cap so as to preserve access to the hollow channel of the healing cap when the internal cavity of the temporary crown is filled with a curable dental material;

FIG. 8A is a perspective view showing a portion of the cuff body of the healing cap being customized by removal with a dental burr;

FIG. 8B is a perspective view showing the cuff body being customized by building up with application of a dental material (e.g., curable);

FIG. 8C is a perspective view of the arch of FIG. 1E in which an anatomical healing cap according to the present invention has been coupled into the implant, leaving no gap between the cuff body of the healing cap and the gingival tissue surrounding the emergence portion of the void;

FIG. 8D is another perspective view of the arch of FIG. 8C showing how the cuff body of the healing cap is anatomically configured to have an asymmetrical cross-section and irregular surface so as to fill the emergence portion of the void, leaving no gaps so as to better preserve the emergence profile of the natural tooth and gingival tissue, including the height of contour associated with the gingival cuff, the buccal prominence of the gingiva, and the interdental papilla gingival tissue; and

FIG. 8E is another perspective view of the arch of FIG. 8C in which a temporary crown has been formed over the healing cap while preserving access to the hollow channel of the healing cap.

### DETAILED DESCRIPTION OF THE PREFERRED EMBODIMENTS

### I. Introduction

One problem with conventional healing caps and related methods of oral surgery is that those features of the gingiva that provide much of the characteristic natural aesthetic appearance of natural teeth and adjacent gum tissue are almost always lost once a tooth is pulled and replaced with a prosthesis. In particular, the gingival tissue surrounding the crown of a natural tooth where it emerges (i.e., its emergence profile) is lost during such procedures.

The gingival cuff refers to the generally scalloped pattern of the gingival tissue that is most prominently seen along the buccal surface of the teeth. The height of contour of the gingival cuff refers to the difference between the most occlusal extension of the gingiva (i.e., between teeth) as compared to its location at the center of a tooth. Generally, the height of contour of the gingival cuff is greatest at a location between two adjacent teeth. In other words, the location of the gingival cuff extends occlusally to its greatest extent at this location between the teeth. At a location corresponding to a buccal center face of a tooth, the location of the gingival cuff exhibits its lowest occlusal extension.

When a natural tooth is pulled and eventually replaced with a custom crown or other prosthesis, much of the dynamic range of the previous height of contour is lost because the gingival tissue between adjacent teeth recedes, and is lost.

Gingival tissue disposed between adjacent teeth is often referred to as the interdental papilla. This tissue resides between the void resulting from the pulled tooth and the adjacent remaining tooth. As a result of the loss of the tooth, the interdental papilla may atrophy and fill the void over time. As a result, much of the interdental papilla tissue, particularly the initial and desirable aesthetic characteristics of this tissue, also tends to be lost upon removal of the natural tooth.

At the extreme gingival edge of the gingival cuff there is gingival tissue that overlies the underlying jaw bone. This gingival tissue typically exhibits a prominence in the buccal direction (i.e., it sticks out or protrudes bucally) and is often referred to as buccal prominence. While the gingival tissue over this bony tissue is not necessarily lost, the prominence by which the tissue sticks out bucally is typically lost when a natural tooth is pulled.

The present invention is directed to devices, systems, and methods for better preserving these features of the gingival tissue surrounding a natural tooth that is pulled. The devices, systems, and methods also aid in reconstructing or creating gingival tissue surrounding a tooth that was previously lost or congenitally missing. According to one embodiment, a chair-side customizable sculptable anatomical healing cap is provided. The sculptable anatomical healing cap includes a hollow elongate body extending between a proximal end and a distal dental implant insertion end. An enlarged cuff body extends laterally outward relative to the hollow elongate body, and is disposed between the proximal end and the distal end of the elongate body. The enlarged cuff body includes an asymmetrical cross-section and an irregular surface which is specifically configured to provide substantially custom filling of at least the emergence portion of the void that results upon removal of a selected tooth of a person's dental arch. The emergence portion of the void refers to the gingival, upper portion of the void, adjacent to where the natural tooth once emerged or would have emerged from the void.

In addition, the enlarged cuff body comprises a sculptable material (e.g., it is not formed of metal) so that a practitioner can remove select portions of the cuff body, add to the cuff body with a dental material that will adhere (e.g., curable composite, other curable dental materials, other adhering dental materials, etc.), or both. This allows the practitioner to chair-side fully customize the cuff body so that it provides a customized fit that custom fills the emergence portion of the void resulting from removal of the selected tooth or aids in creating the desired natural gingival contours of a missing tooth.

Because the emergence portion of the various tooth positions are not identical to one another (but they do remain substantially the same from one person to another person when considering the same tooth position), different sculptable anatomical healing caps are provided for the various tooth positions, which differ in the particular configuration of the enlarged cuff body of the respective healing cap. For example, separately configured healing caps may typically be provided for the upper central incisors, the upper lateral incisors, the upper cuspids, the upper bicuspids, and the upper molars. A set of healing caps for the teeth of the lower dental arch may be similarly provided, e.g., lower incisors, lower cuspids, lower bicuspids, and lower molars. It may be possible to use identically configured healing caps for some teeth (e.g., first and second bicuspids, or first and second molars).

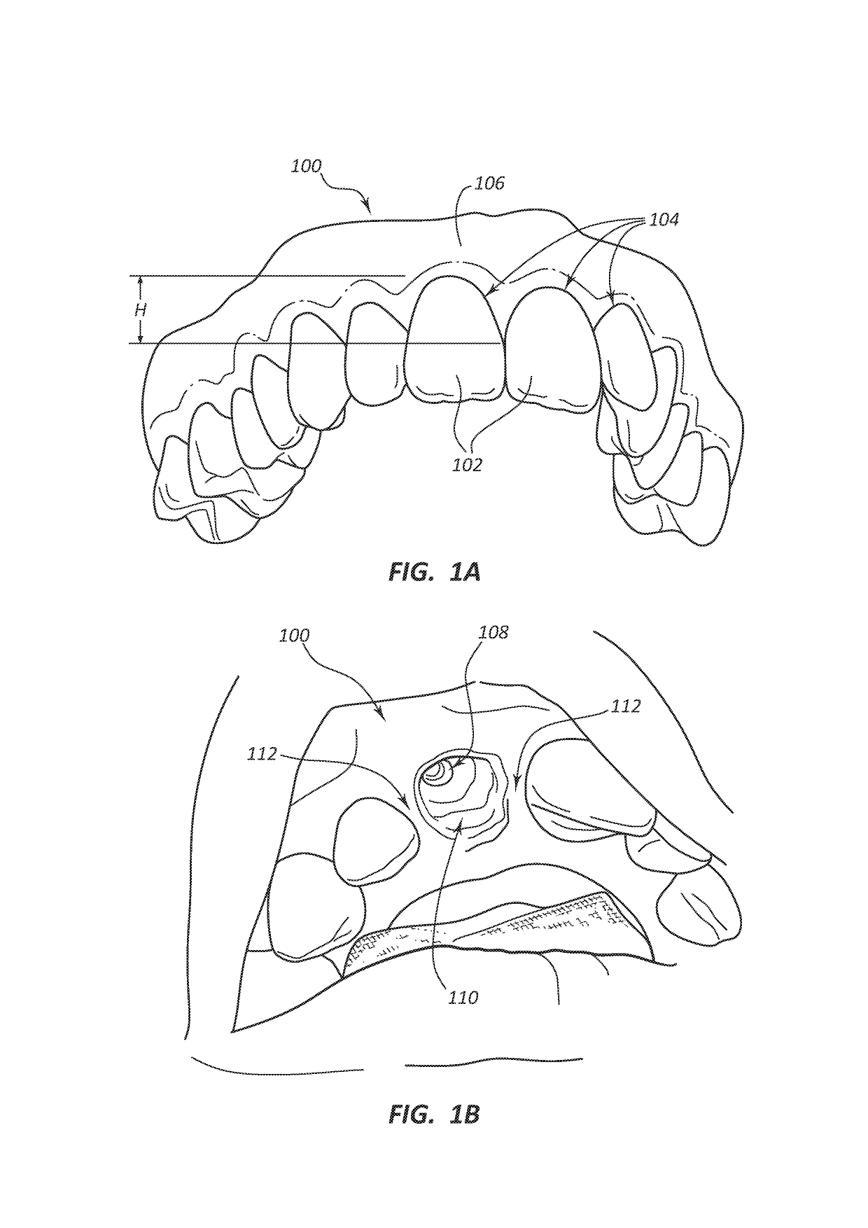

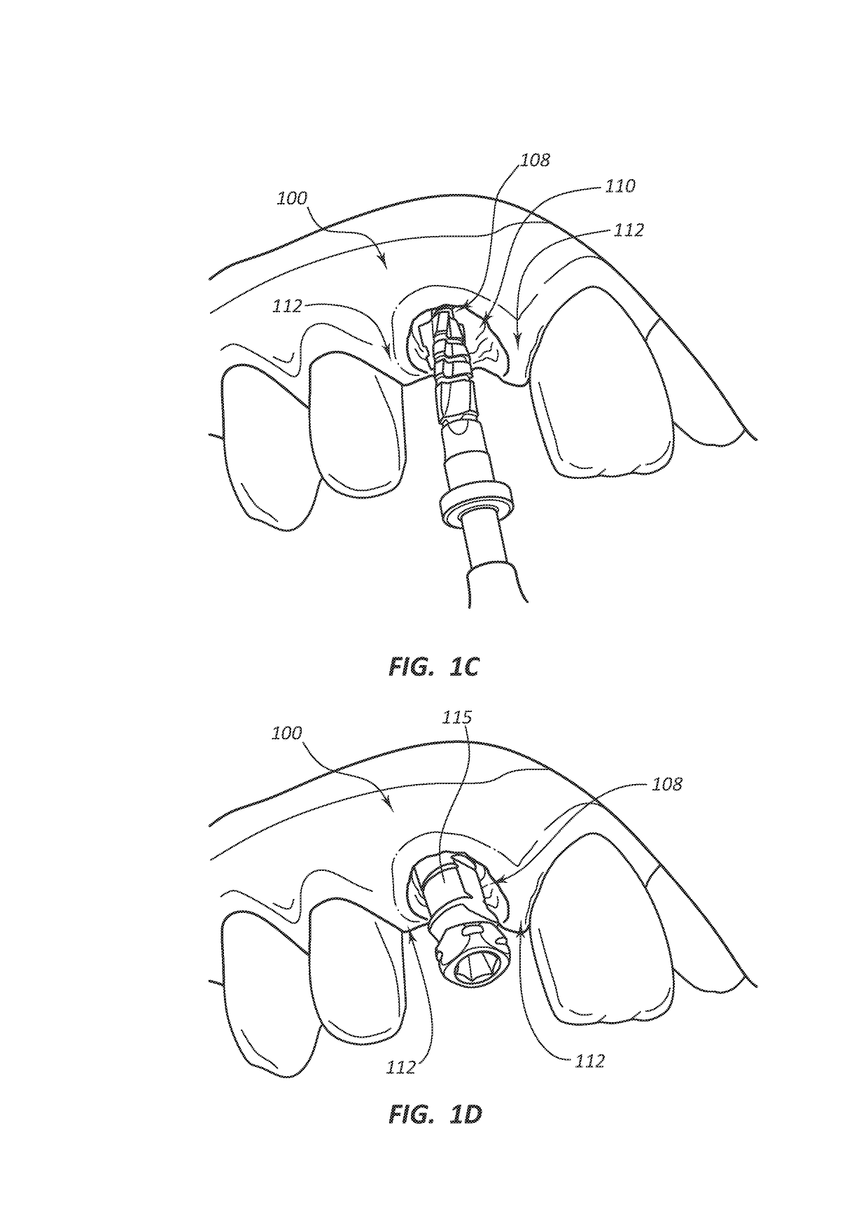

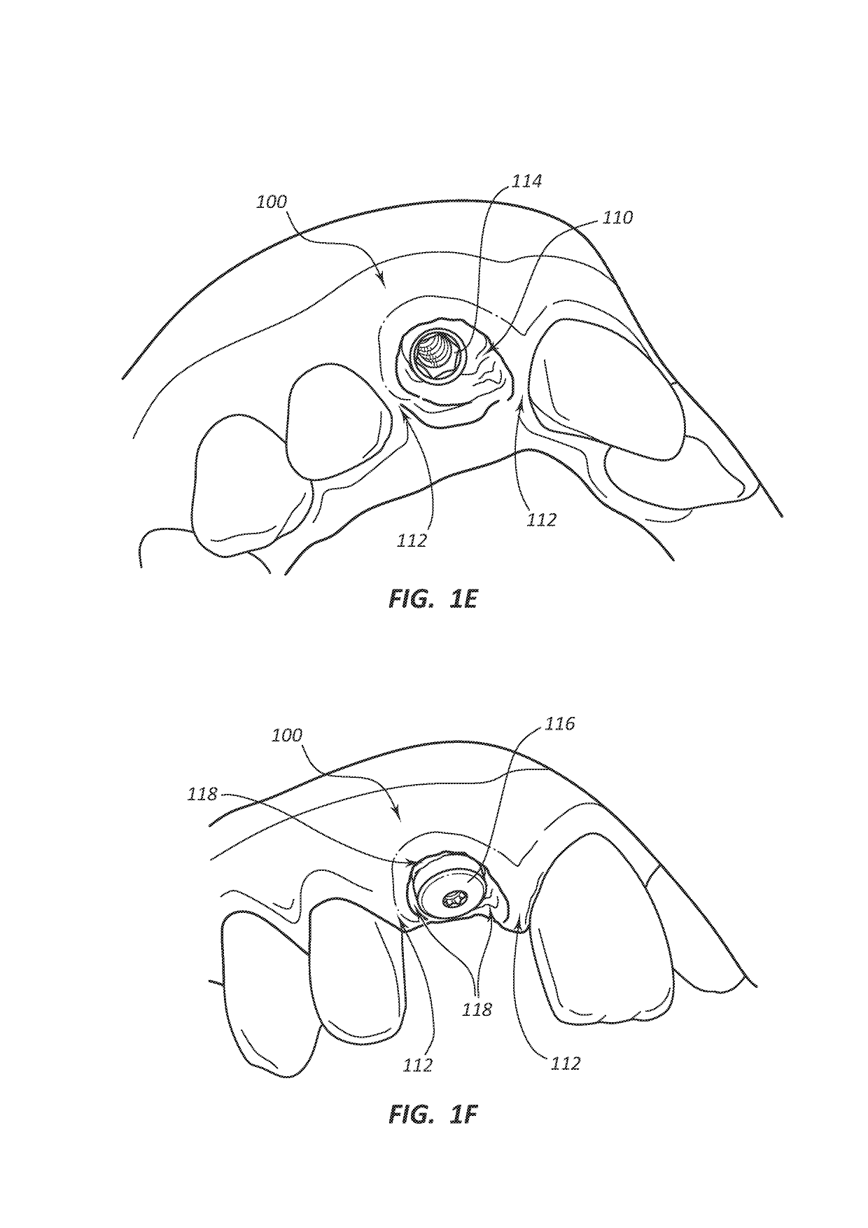

FIGS. 1A-1F illustrate an upper dental arch, as well as typical steps employed in removal of a tooth, installation of an implant, and placement of a state of the art healing cuff or cap. For example, FIG. 1A shows a person's upper dental arch 100 including central incisors 102. Also apparent in FIG. 1A is the gingival cuff 104 where the natural teeth emerge from the gingival tissue, and the typical height of contour where the highest contour H₂ is between two adjacent teeth, while the lowest contour or point along the gingival cuff is H₁, at the center of the buccal face of the teeth. The difference H between H₂ and H₁ represents the height of contour associated with the natural teeth and gingival cuff prior to removal of the natural tooth.

In addition to the gingival cuff, a buccal prominence 106 is associated with the gingival edge of gingival cuff 104, disposed gingivally relative to the crown of each respective tooth (e.g., labeled buccal prominence 106 corresponds to tooth 102). FIG. 1B shows the dental arch 100 after central incisor 102 has been removed, leaving a void 108 once occupied by the root of tooth 102. The top or most gingival portion of void 108 is the emergence portion 110 of void 108, whose contours are defined by the shape of the emergence portion of the tooth 102, just below the crown portion of the tooth. Also apparent in FIG. 1B is the interdental papilla 112.

The customizable sculptable anatomical healing caps of the present invention are specifically configured to preserve or restore or create (in the case of missing teeth) as much of this gingival tissue, its emergence profile, and other features as possible.

As shown in FIG. 1C, the void 108 is prepared to receive a dental implant 114 by drilling into the bone tissue of the underlying jaw bone at the bottom of void 108, after which a dental implant 114 may be inserted therein, as shown in FIG. 1D-1E. FIG. 1D shows a transfer coping 115 or similar structure being used to aid in seating the implant 114 into void 108. FIG. 1E illustrates a view down into void 108 once dental implant 114 has been fully seated within the prepared underlying bony tissue (and transfer coping 115 has been uncoupled from implant 114). Much of the lower portion of void 108 may be filled by dental implant 114, while the emergence portion 110 remains unfilled. FIG. 1F shows installation of a state of the art healing cap or cuff 116, which couples into dental implant 114. Healing cap or cuff 116 is typically provided in various sizes, each of which is cylindrical (e.g., each of a different diameter and/or height). A healing cap or cuff is selected from the available sizes and coupled into dental implant 114. Healing cap or cuff 116 may remain in place for several weeks (e.g., 1.5 to 6 months) while the site heals. As shown in FIG. 1F, because the healing cap or cuff 116 is not anatomically shaped to fill the emergence portion 110 of void 108, gaps 118 remain between healing cap or cuff 116 and the gingival walls defining emergence portion 110. Placement of the healing cap or cuff 116 may be the end of what is termed the first stage procedure. It will be understood that while described in terms of various stages, healing caps or cuffs 116 may be placed in various other oral surgery procedures (e.g., second stage, immediate placement, subsequent placement, etc.). Similarly, the inventive devices, systems and methods may be employed in various oral surgery procedures (e.g., during a first or second stage procedure, in an immediate placement procedure, in a delayed placement procedure, or in any other appropriate oral surgery procedure). The greatest benefit may be obtained where the inventive devices are placed immediately or soon after placement of the implant, so that the gingival tissue is immediately supported, and loss of desired gingival tissue features is minimized.

By way of example, in a subsequent second stage procedure, after a healing period of at least several weeks, the person may return to the practitioner's office, the healing cap or cuff 116 may be removed, and a permanent prosthesis may be installed by coupling into implant 114. During the healing period, the gingival tissue surrounding healing cap or cuff 116 progressively adapts to the shape provided by healing cap or cuff 116, collapsing into, growing into, or otherwise filling gaps 118. In addition, the height of contour of the gingival cuff tends to be compressed (i.e., reduced) as the tissue between adjacent teeth recedes, the interdental papilla fall or otherwise fill gaps 118, and the buccal prominence 106 recedes so as to be less prominent bucally. As a result, the emergence profile and other desirable gingival features are compromised. At this stage, even if one were to install a crown or other prosthesis that were a perfect match to the natural tooth, including the subgingival emergence portion, it is often too late to recapture the prior characteristics of the surrounding gingival tissue, which have been lost. Furthermore, when installing such a prosthesis at this later stage, the gingival tissue that has grown into gaps 118 is often cut away or compressed in order to make space for the prosthesis. Such activity can lead to subsequent necrosis of the gingival tissue.

### III. Exemplary Customizable Sculptable Anatomical Healing Caps

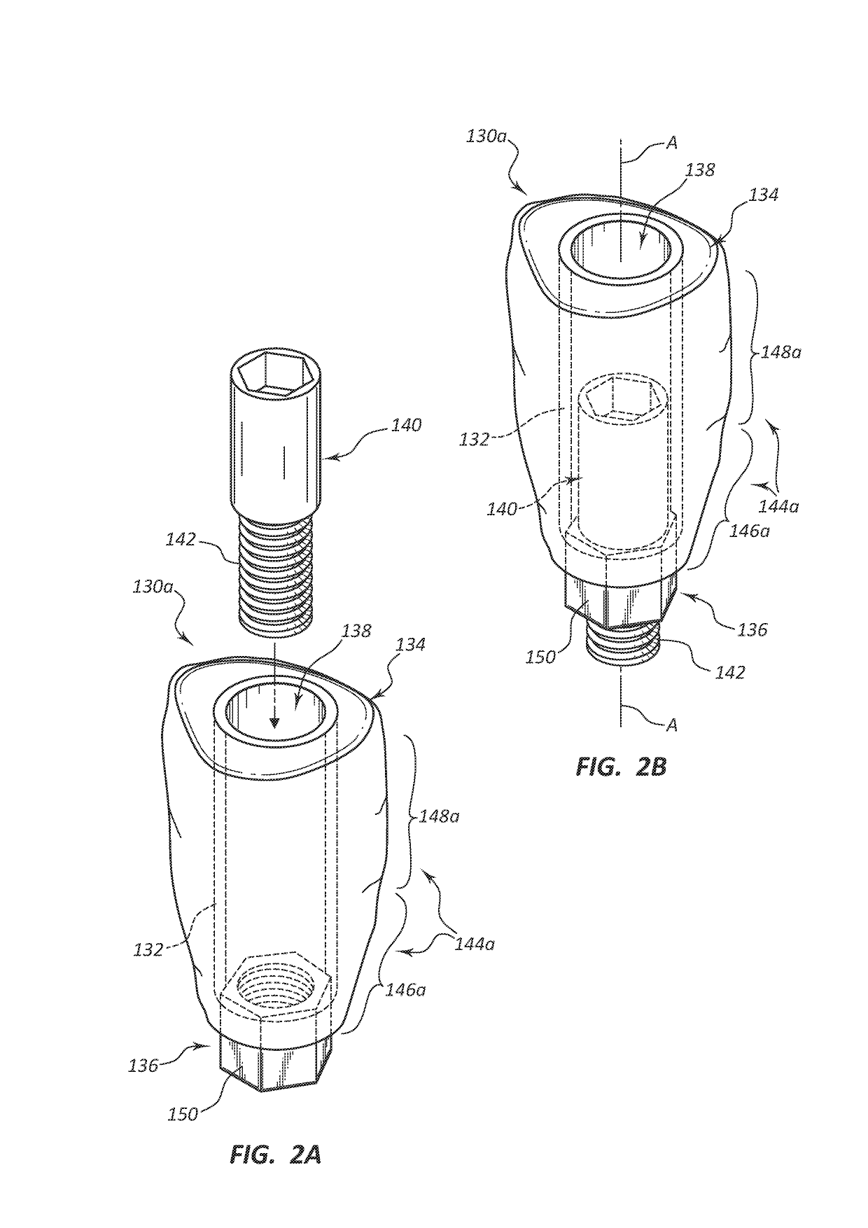

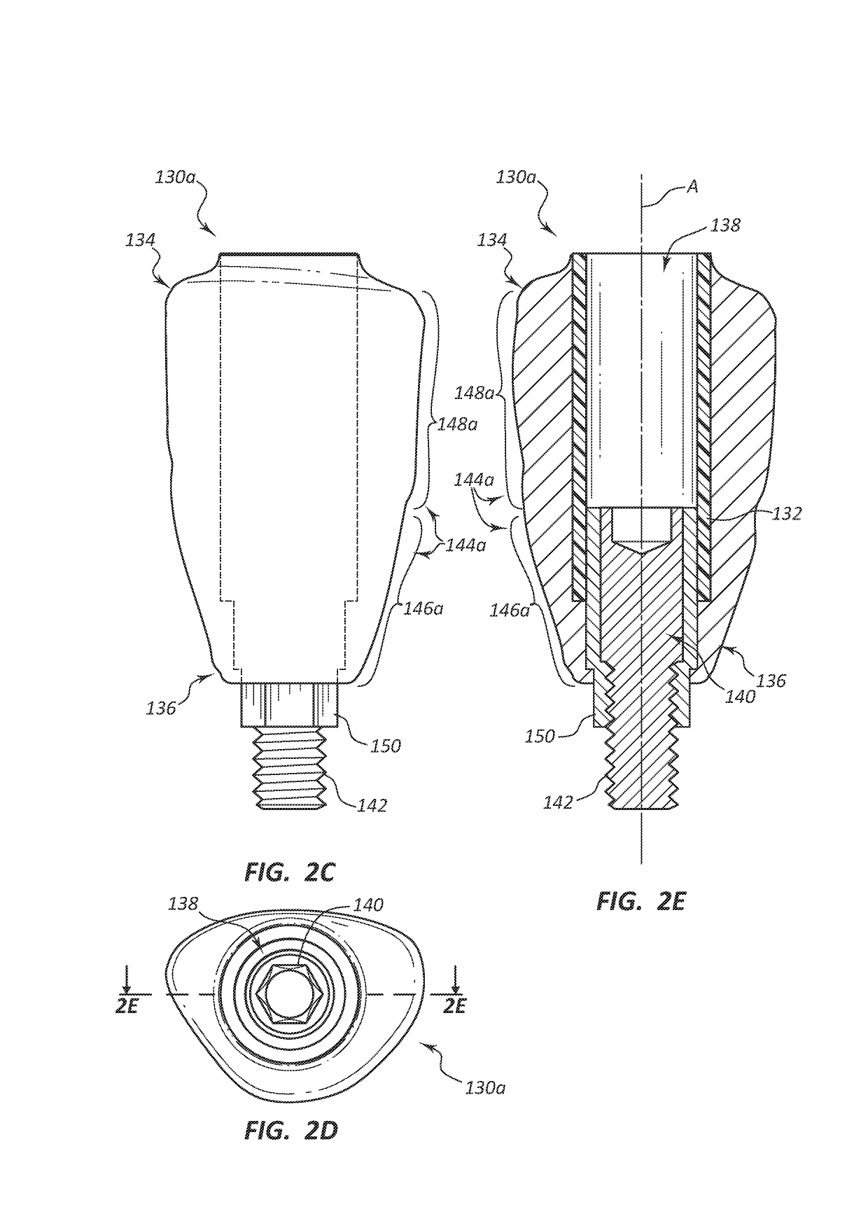

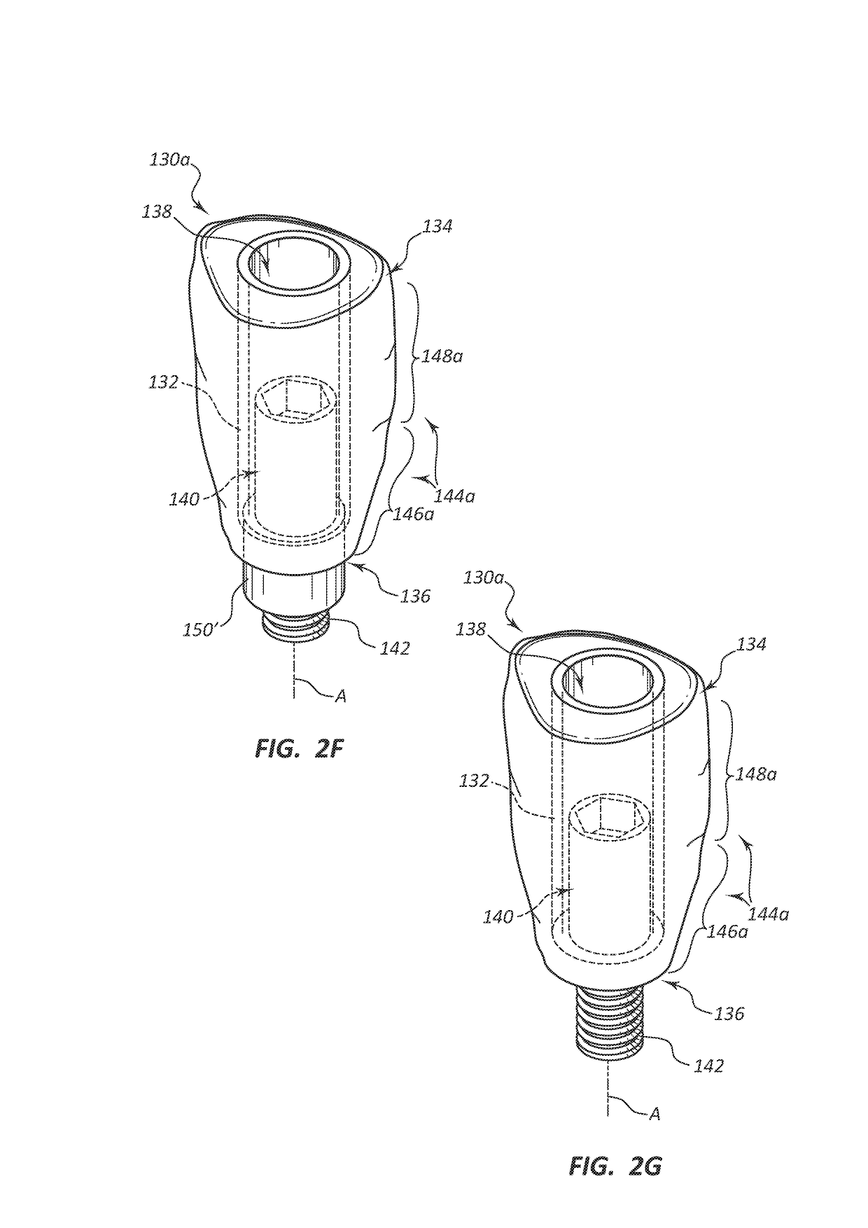

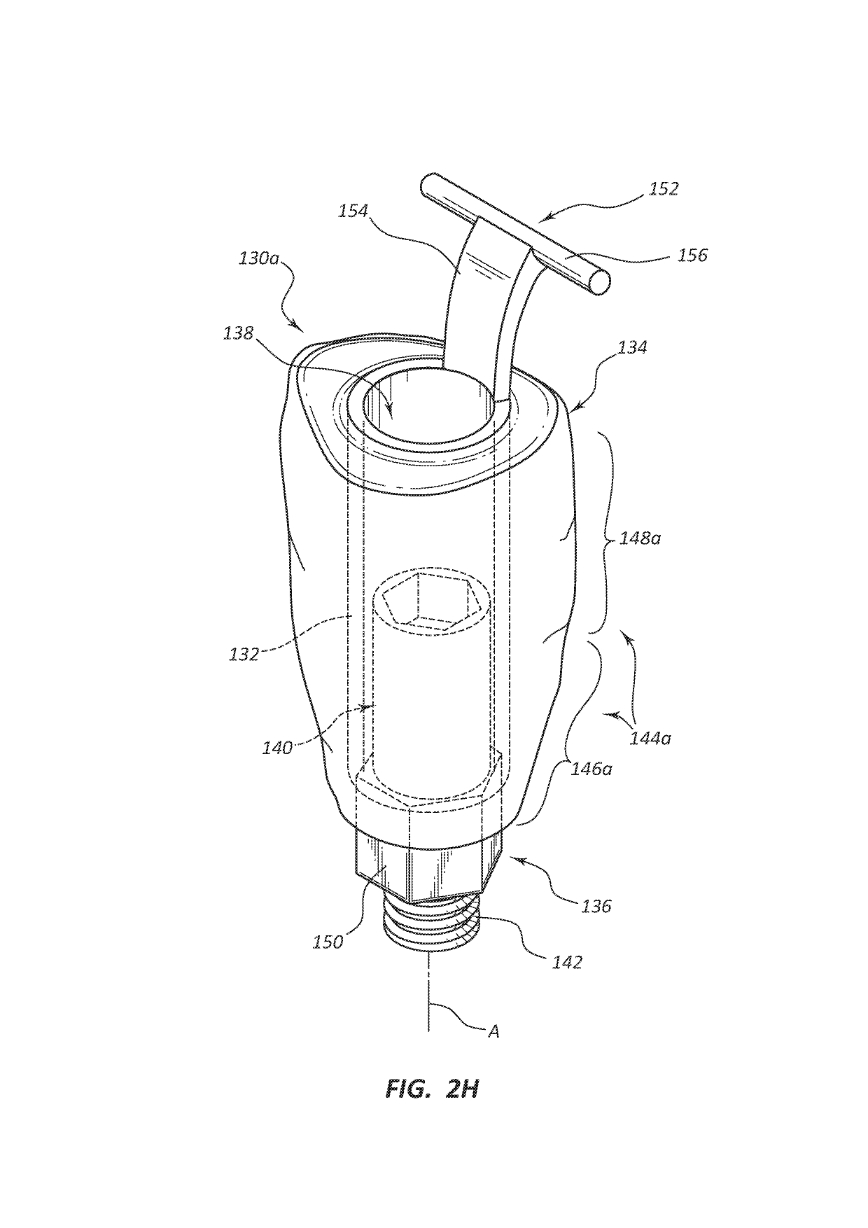

FIGS. 2A-2E illustrate various views of an exemplary sculptable anatomical healing cap 130a configured to fill the emergence portion of a void resulting from removal of an upper central incisor. Sculptable anatomical healing cap 130a includes an elongate body 132 extending between a proximal end 134 and a distal dental implant insertion end 136. Body 132 is advantageously hollow, including a hollow channel 138 with open ends and extending generally along longitudinal axis A so as to allow insertion of coupling screw member 140 into hollow channel 138, by which external threads 142 can be coupled into corresponding internal threads of a dental implant 114.

Sculptable healing cap 130a advantageously includes an enlarged cuff body 144a extending laterally outward from hollow elongate body 132. Enlarged cuff body 144a is disposed between proximal end 134 and distal end 136, and advantageously is shaped, as mass-manufactured, to provide a substantially custom fit so as to fill emergence portion 110 of void 108. In the illustrated configuration, cuff body 144a includes a subgingival or lower portion 146a and an exposed or upper portion 148a. Subgingival portion 146a becomes inserted within emergence portion 110 of void 108 during use, while exposed portion 148a resides gingivally above void 108.

Both portions 146a and 148a may be shaped to mimic the shape of the natural tooth which may have immediately prior resided within void 108. In particular, subgingival portion 146a is shaped to mimic that portion of the natural tooth which resides immediately below the gingival surface, so that this portion 146a mimics the emergence portion including the emergence profile of the natural tooth. In order to mimic the natural tooth contours just below the gingival surface, the subgingival portion 146a includes an asymmetrical cross-section and an irregular surface which mimic the emergence portion and emergence profile of the natural tooth. This allows portion 146a to provide substantial custom filling of emergence portion 110 of void 108 resulting from removal of an upper central incisor 102.

Portion 148a may also be shaped to mimic the shape and contour of the natural tooth, although portion 148a resides above void 108. The emergence profile is defined by the interface between the subgingival portion 146a and exposed portion 148a. In some embodiments, exposed portion 148a may be omitted, although it may be preferable to include an exposed portion so as to provide a surface that extends somewhat above the gingival tissue around the emergence profile, to better preserve the natural features of the emergence profile gingiva. For example, this provides support structure against which the gingival tissue can be supported and prevented from collapsing, even where the particular person's emergence profile may differ somewhat from the mass-manufactured subgingival portion 146a that approximates a custom fit. In one embodiment, the exposed portion 148a does not extend occlusally to the same extent that a normal natural tooth would. For example, occlusal features, including cusp features of the natural tooth may simply be omitted (e.g., the occlusal or top surface of the exposed portion 148a may simply be a generally flat surface, with a hole therein where hollow channel 138 intersects the generally flat surface.

In one embodiment, hollow channel 138 of body 132 may be bounded by a cylindrical or other shaped wall, which may or may not extend proximally above exposed portion 148a.

At least subgingival portion 146a of cuff body 144a comprises a sculptable material so that a practitioner can easily remove select areas of portion 146a, can add to (i.e., build up) portion 146a with a dental material that will adhere (e.g., a curable dental material), or both so that portion 146a can be chair-side fully customized to provide an exact, custom fit that fills emergence portion 110 of void 108. Sculptability is advantageous because while the shape and size of the emergence portion 110 of void 108 is more or less the same for different persons for a particular given tooth position (e.g., generally all persons will have very similar emergence portions for their upper central incisors), individual people do vary somewhat from individual to individual, and the ability to easily remove material, add material, or both relative to portion 146a allows the practitioner to fully customize portion 146a for a given emergence portion 110 of void 108.

Of course, in some embodiments, more than a single size cuff body may be provided for any given tooth position. For example, children may exhibit differently sized emergence portions as compared to adults for a given tooth position. Similarly, some individuals may have particularly large or small teeth, so that their emergence portions may vary somewhat from the normal or average size. As such, in one embodiment, different sizes (e.g., normal adult size, a “large” adult size, a “small” adult size, and/or a child size) may be provided, such that the practitioner may choose the most appropriate size, which may then be fully customized by sculpting. Because the cuff body is sculptable, a practitioner may simply add to or remove material as needed to achieve the desired size.

In one embodiment, subgingival portion 146a may intentionally be sized to be slightly larger than the typical average emergence profile, so that the practitioner may shave or otherwise remove portions therefrom (e.g., with a dental burr, scalpel or other suitable tool) immediately prior to placement. This may be advantageous as it may be easier and less time consuming to typically require removal of material rather than supplementation, where material must be added to fully customize the subgingival portion 146a. In some embodiments, it may be expected that little or no modification (either removal or adding to) may be required. As such, the size and shape provided is already substantially perfectly configured to fill the person's emergence portion 110 of void 108 (with substantially no gaps), providing the same emergence profile as was provided by the natural tooth to thereby support the gingival tissue.

In one embodiment, the subgingival portion 146a, and preferably the entire cuff body 144a is therefore not formed of metal, but comprises a material that may be easily and conveniently shaved or cut away, as well as added to. Such suitable materials include any of various plastic materials, dental composite materials, or other materials that can be readily customizable through use of a dental burr, scalpel, or other suitable tool. In one embodiment a radiopaque filler may be incorporated into the plastic or composite so that the subgingival structures of the healing cap can be viewed by x-ray or other imaging technique. Such materials also advantageously will readily bond to curable or other suitable adhering dental materials applied thereto where it is desired to add size or adjust contour to the as mass-manufactured cuff body. In one embodiment, the entire elongate body and enlarged cuff body may comprise a single piece of material (e.g., plastic or composite material).

In one embodiment, the exterior surface of cuff body 144a, particularly subgingival portion 146a, may be treated for stimulation of bone or other tissue growth. For example, the material of body 144a or portion 146a may be particularly selected so as to stimulate growth (e.g., a calcium containing material such as hydroxyapatite or similar bone growth promoting material), or the surface may be mechanically (e.g., roughened, smoothed, specific texture patterned), chemically, or otherwise treated to stimulate desired growth.

In one embodiment, the distal dental implant insertion end 136 of sculptable anatomical healing cap 130a may include a locking member 150 with a non-circular perimeter configured for insertion into a correspondingly shaped proximal end of a dental implant 114. In the illustrated configuration, the locking member 150 is hexagonal. Other configurations similarly configured to lock against rotation will be readily apparent to one of skill in the art (e.g., triangular, 4-sided, 5-sided, use of non-circular curved sides (e.g., an oval), combination of straight and curved sides, etc.). This locks the healing cap 130a against rotation once inserted within the dental implant 114. Any suitable anti-rotation locking mechanism, including those proprietary to various dental implant manufacturers within the art, may be employed.

In another embodiment, the distal dental implant insertion end 136 may include a circular locking member 150′ (see FIG. 2F). In another embodiment, no locking member at all is provided (see FIG. 2G). In the embodiment of FIG. 2G, external threads 142 are simply coupled into corresponding internal threads of dental implant 114, and the shape of subgingival portion 146a itself can serve to prevent rotation, as this portion is non-circular and engages against the gingival tissue bounding emergence portion 110 of void 108. Other coupling mechanisms between the healing cap and dental implant 114 are possible. For example, the location of internal and external threads may be switched (i.e., internal threads on healing cap, and corresponding external threads on dental implant). Various other suitable coupling mechanisms will be apparent to one of skill in the art in light of the present disclosure.

In one embodiment, a removable grippable handle may be provided at the proximal end 134 of body 132. As shown in FIG. 2H, a grippable handle 152 may be provided. Handle 152 may include a shaft 154 extending proximally upwards from elongate body 132, cuff body 144a, or both. In one embodiment, shaft 154 may be disposed adjacent the buccal surface of body 132, cuff body 144a, or both, which advantageously orients the handle in the most suitable position during insertion into void 108. As shown, handle 152 may be generally T-shaped, including a cross-bar 156 atop or near top of shaft 154. Shaft 154 and/or cross-bar 156 provide surfaces that can be easily gripped by dental pliers or another suitable tool available to the practitioner. Once the healing cap is placed within void 108, handle 152 may be removed (e.g., cut away).

While the illustrated configuration is shown with cuff body 144a generally aligned with axis A of channel 138, in another embodiment, the axis A of channel 138 may be offset relative to an axis of cuff body 144a. This may be beneficial where the natural tooth (and thus void 108) is mis-aligned relative to what would be “normal”. Such a configuration allows the practitioner to account for such situations.

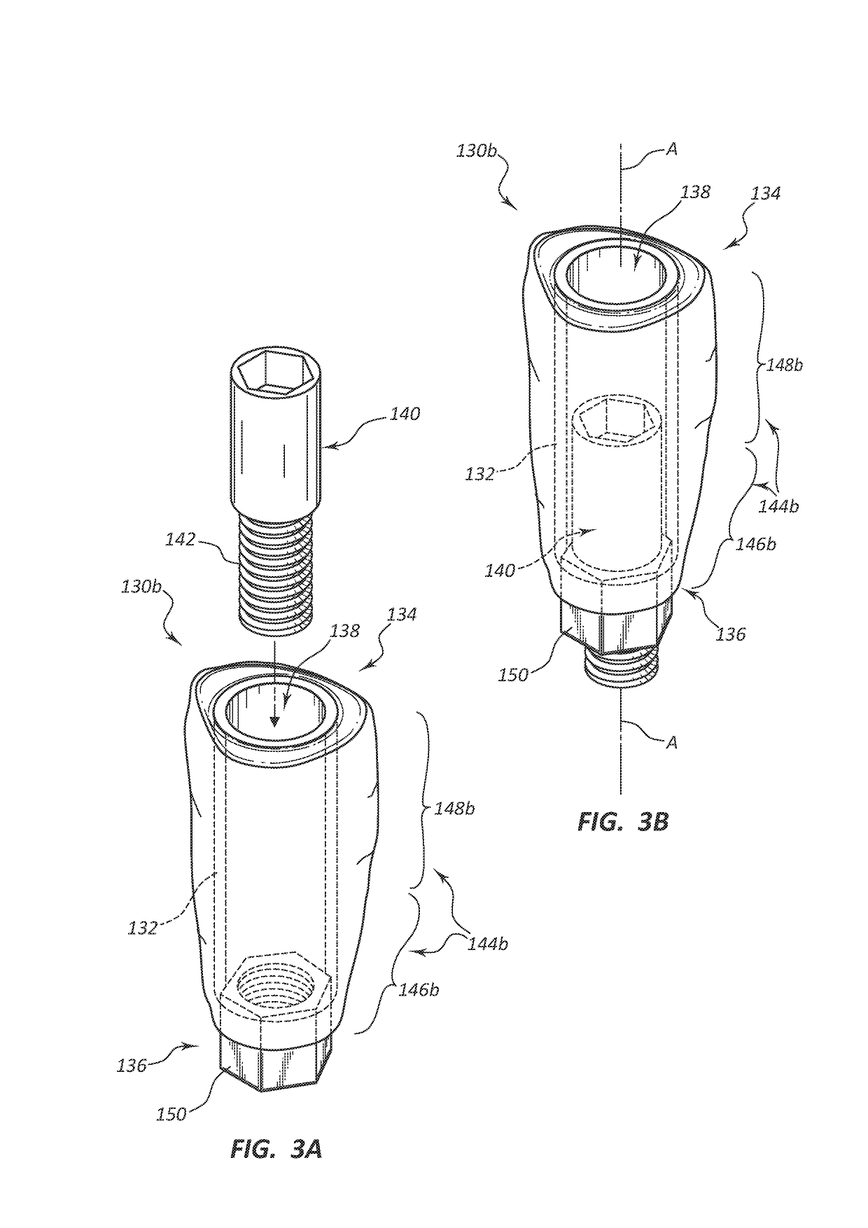

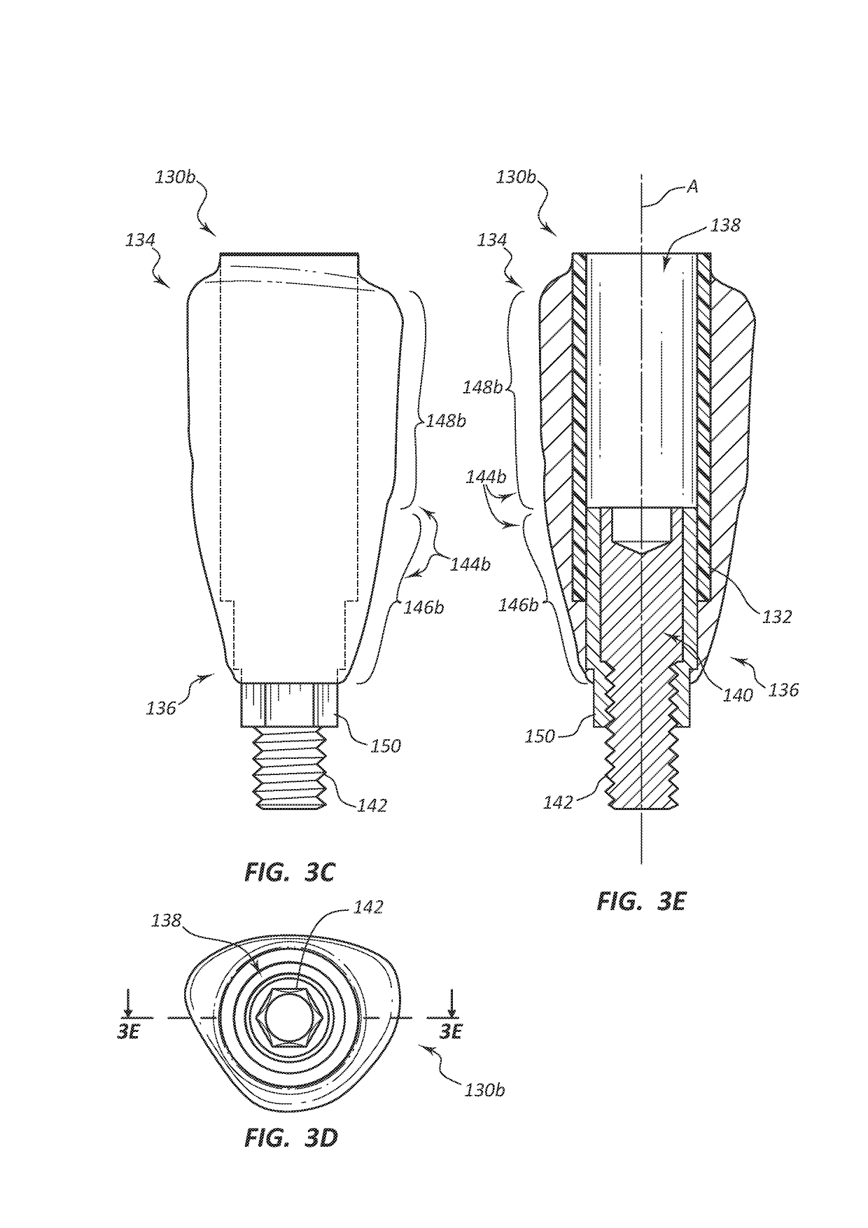

FIGS. 3A-3E illustrate various views of an exemplary sculptable anatomical healing cap 130b configured for insertion within the emergence portion of a void resulting from removal of an upper lateral incisor. Sculptable anatomical healing cap 130b is similar to healing cap 130a, but includes a differently shaped cuff body 144b, subgingival portion 146b, and exposed portion 148b. In particular, subgingival portion 146b is particularly shaped to provide substantially custom filling of an emergence portion of an upper lateral incisor. Although the particular size and shape of subgingival portion 146b is different from that of subgingival portion 146a, both include an asymmetrical cross-section and an irregular surface, each being particularly configured to mimic the emergence portion and emergence profile of the particular tooth they are associated with.

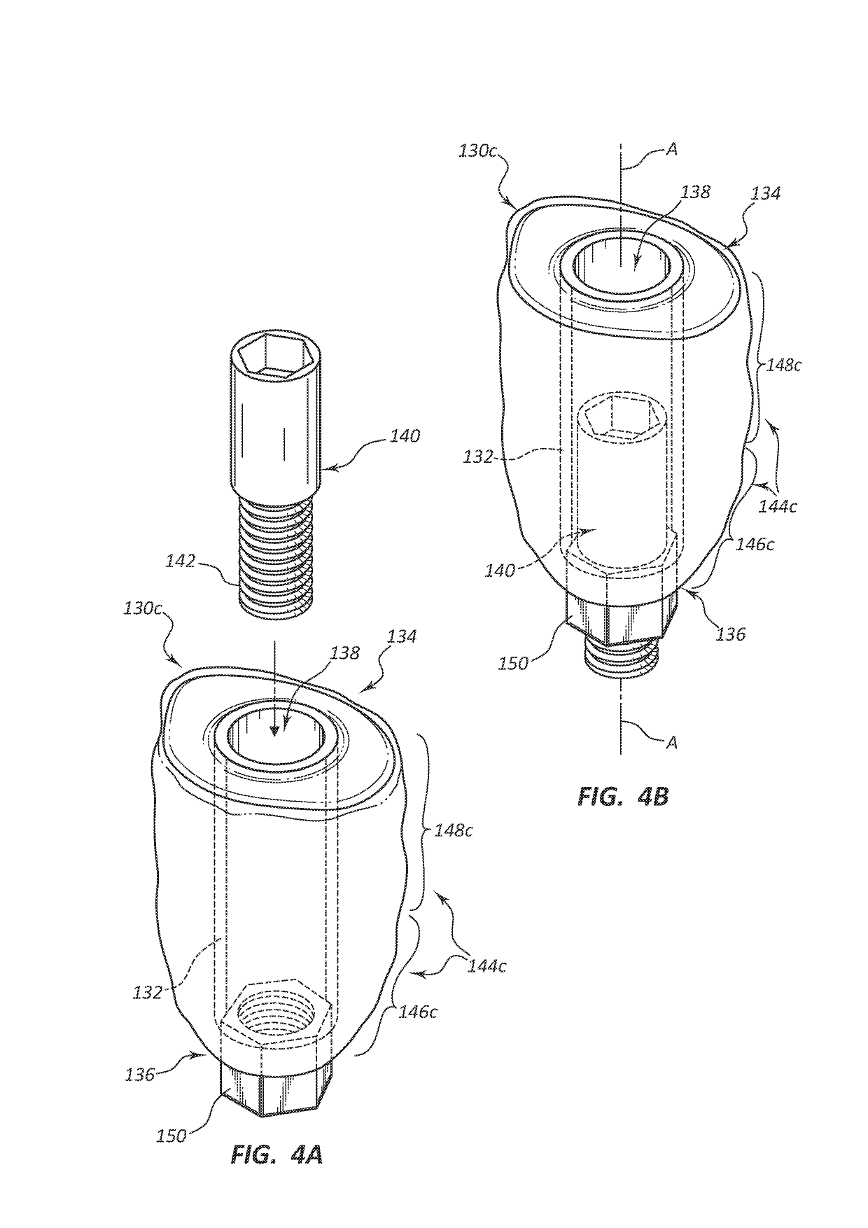

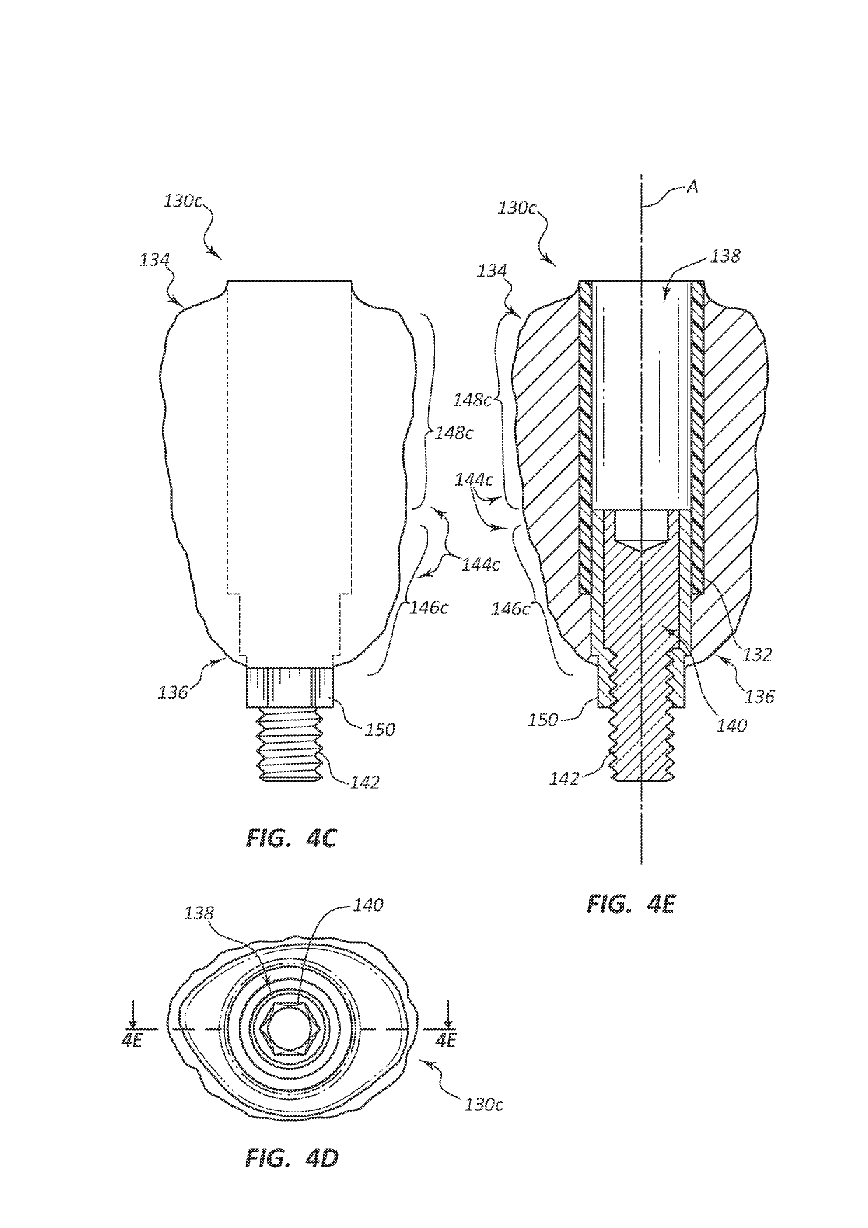

FIGS. 4A-4E illustrate various views of an exemplary sculptable anatomical healing cap 130c configured for insertion within the emergence portion of a void resulting from removal of an upper cuspid. Sculptable anatomical healing cap 130c is similar to healing cap 130a, but includes a differently shaped cuff body 144c, subgingival portion 146c, and exposed portion 148c. In particular, subgingival portion 146c is particularly shaped to provide substantially custom filling of an emergence portion of an upper cuspid. Although the particular size and shape of subgingival portion 146c is different from that of subgingival portion 146a, both include an asymmetrical cross-section and an irregular surface, each being particularly configured to mimic the emergence portion and the emergence profile of the particular tooth they are associated with.

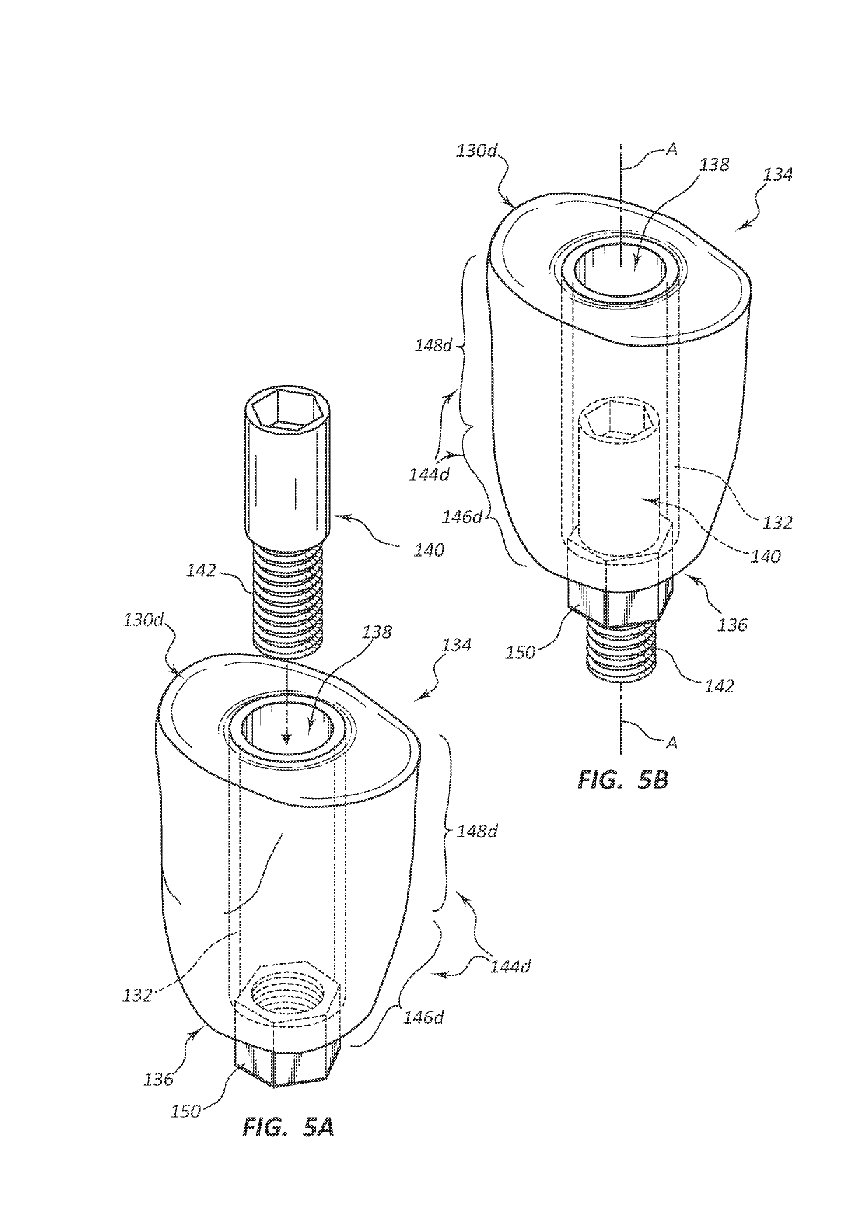

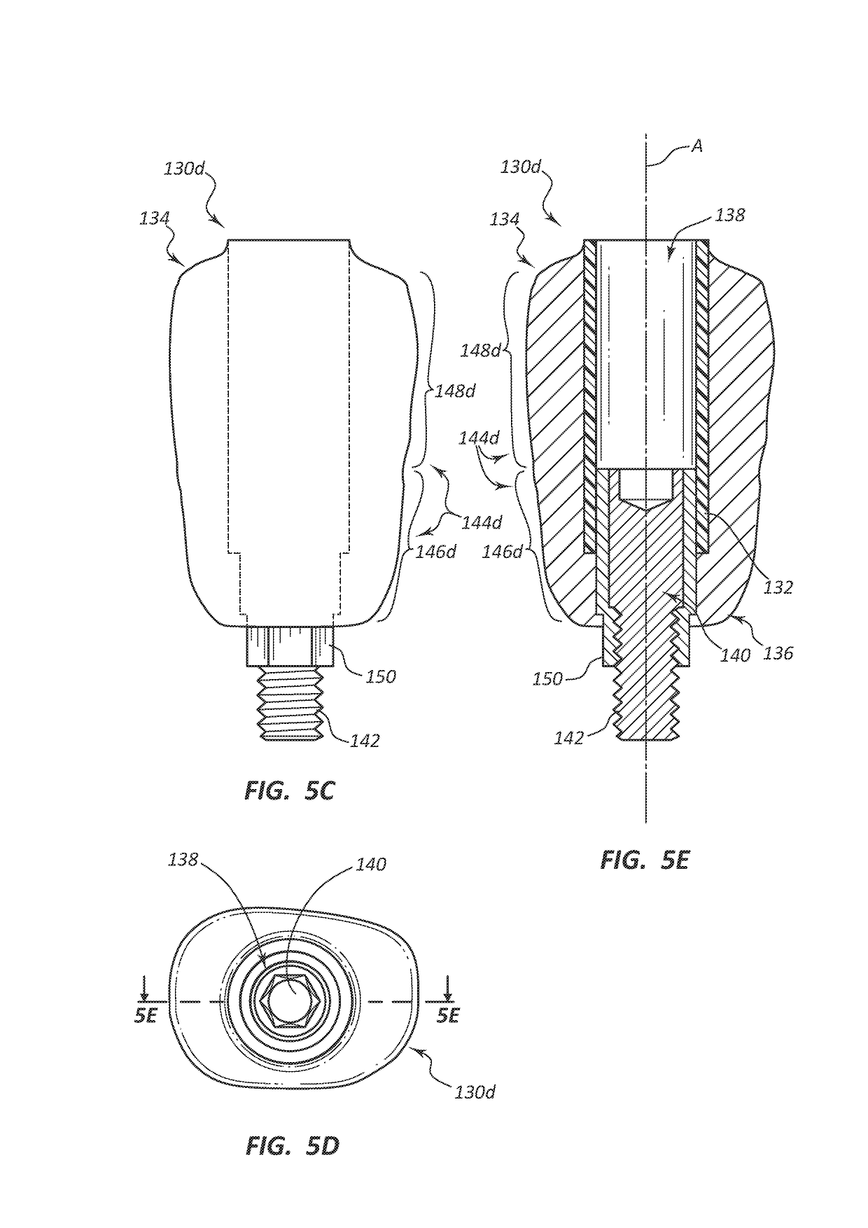

FIGS. 5A-5E illustrate various views of an exemplary sculptable anatomical healing cap 130d configured for insertion within the emergence portion of a void resulting from removal of an upper bicuspid. Sculptable anatomical healing cap 130d is similar to healing cap 130a, but includes a differently shaped cuff body 144d, subgingival portion 146d, and exposed portion 148d. In particular, subgingival portion 146d is particularly shaped to provide substantially custom filling of an emergence portion of an upper bicuspid. Although the particular size and shape of subgingival portion 146d is different from that of subgingival portion 146a, both include an asymmetrical cross-section and an irregular surface, each being particularly configured to mimic the emergence portion and the emergence profile of the particular tooth they are associated with.

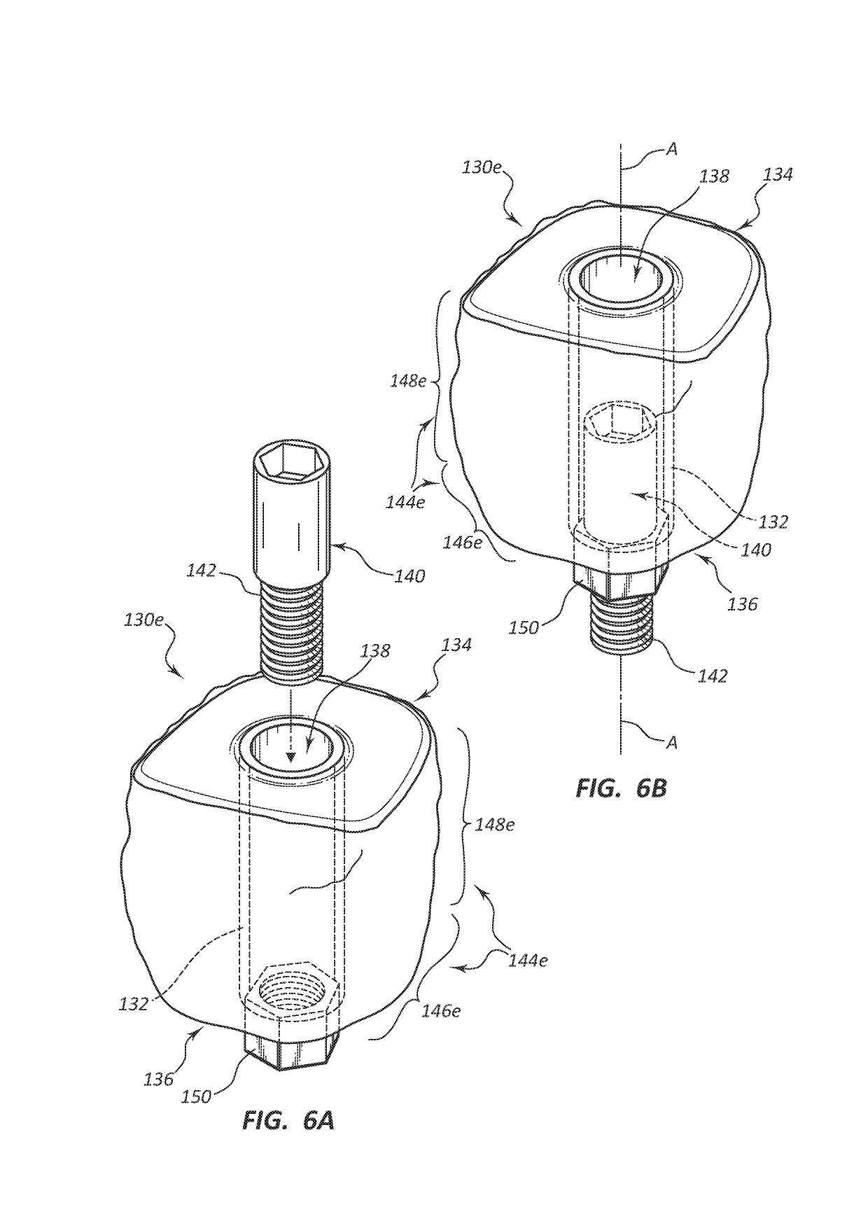

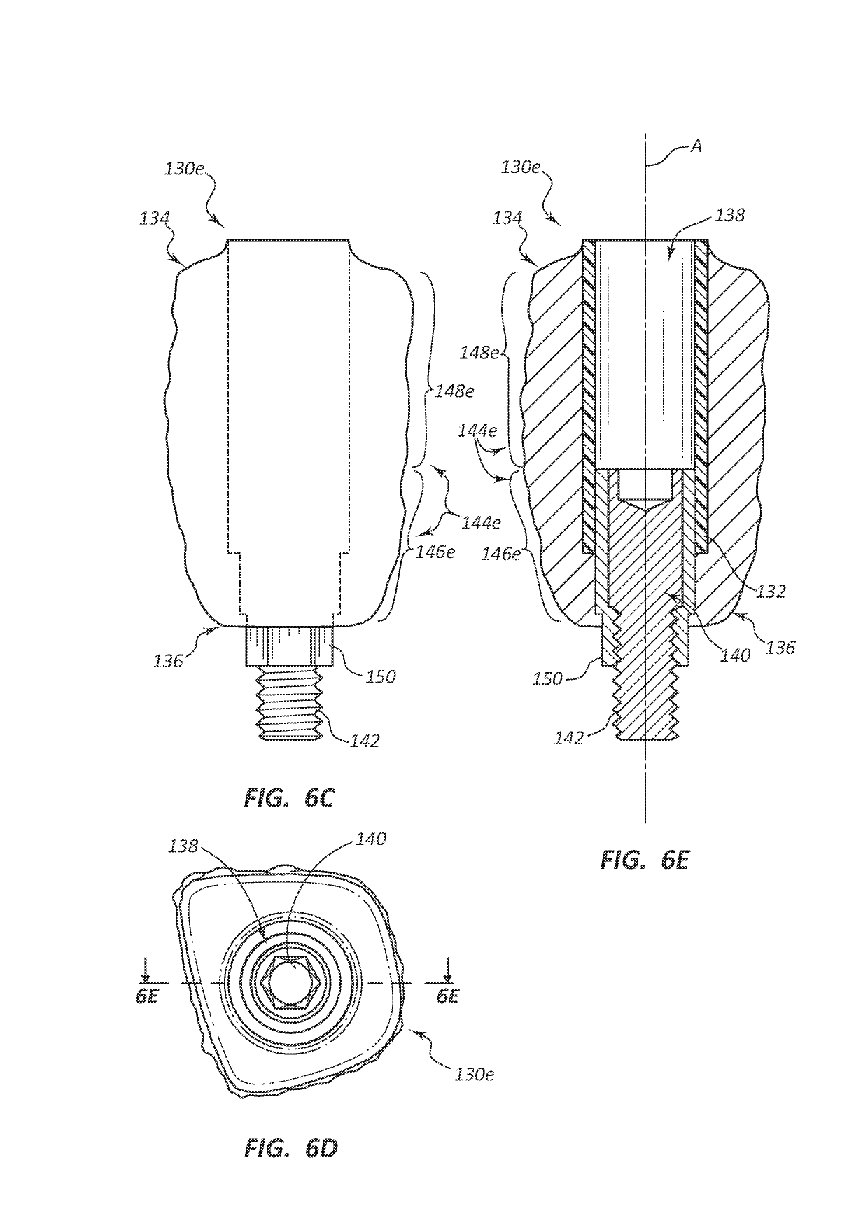

FIGS. 6A-6E illustrate various views of an exemplary sculptable anatomical healing cap 130e configured for insertion within the emergence portion of a void resulting from removal of an upper molar. Sculptable anatomical healing cap 130e is similar to healing cap 130a, but includes a differently shaped cuff body 144e, subgingival portion 146e, and exposed portion 148e. In particular, subgingival portion 146e is particularly shaped to provide substantially custom filling of an emergence portion of an upper bicuspid. Although the particular size and shape of subgingival portion 146e is different from that of subgingival portion 146a, both include an asymmetrical cross-section and an irregular surface, each being particularly configured to mimic the emergence portion and the emergence profile of the particular tooth they are associated with.

The illustrated shapes for various cuff bodies, and particularly subgingival portions 146 are exemplary. To those of skill in the art, and in light of the present disclose, it will be apparent that a single configuration may be suitable for two or more different tooth positions. For example, the illustrated bicuspid configuration of FIGS. 5A-5E may be suitable for use with both the first and second bicuspids. Similarly, the illustrated molar configuration of FIGS. 6A-6E may be suitable for use with both first and second molars. A similar set of healing caps, with appropriately sized and shaped cuff bodies (and subgingival portions) may similarly be provided for each of the unique shaped emergence portions and emergence profiles associated with the lower dental arch. In addition, in some instances, there may be some difference between the healing cuff configuration of a particular tooth position of the right side of a given dental arch versus the left side of the same dental arch.

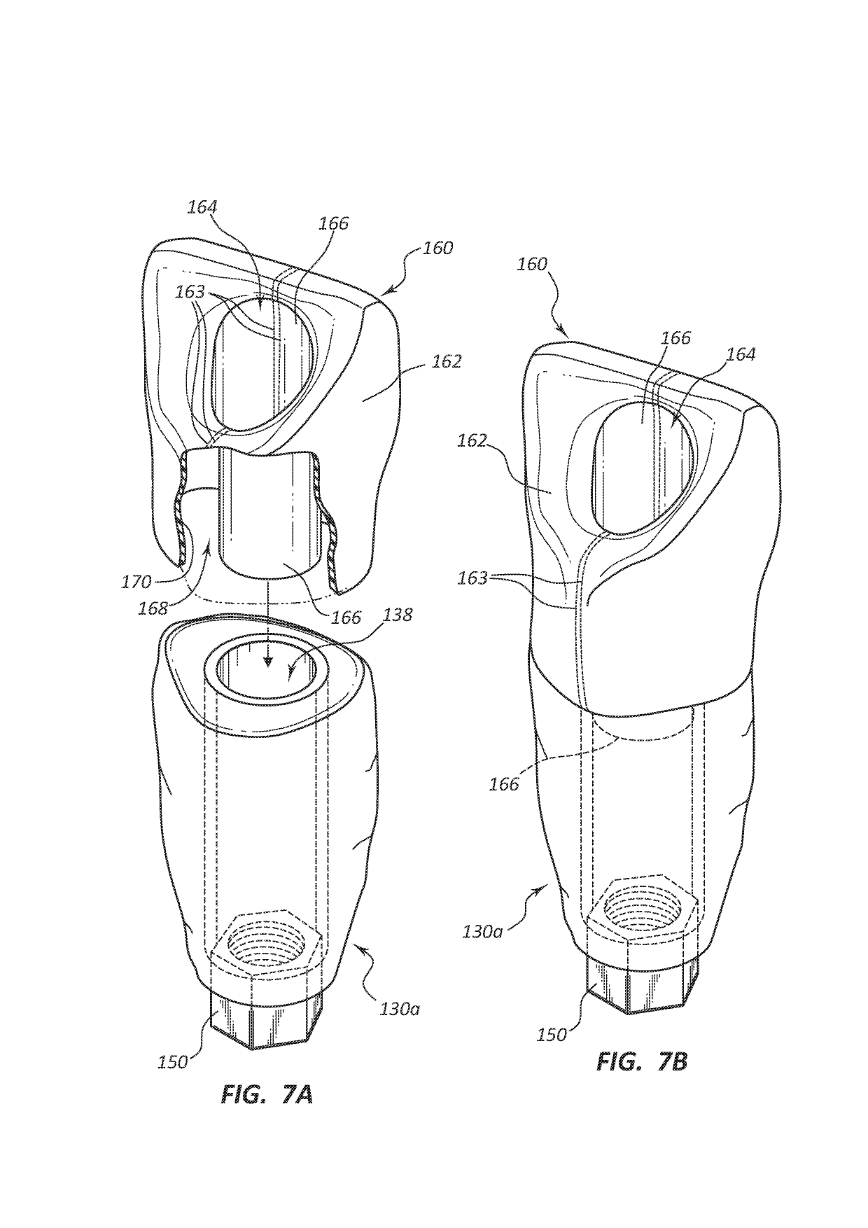

FIGS. 7A-7B illustrate a related system including a sculptable anatomical healing cap as described above (e.g., FIGS. 7A-7B show healing cap 130a of FIG. 2B) in combination with a temporary crown form that may be used with the healing cap in chair-side manufacture and placement of a temporary provisional crown or other prosthesis. Many practitioners will not place a temporary provisional crown when the healing cap is placed or even after the healing cap has been in place for an extended period of time because it can be time consuming and troublesome.

The present inventive system provides a quick and simple method by which a provisional crown can be formed and bonded over the healing cap. In some circumstances, it may be possible to place a temporary crown or similar prosthesis during first stage treatment, at the time of initial placement of the healing cap, immediately after pulling the tooth. In other embodiments, it may be desirable to allow the site to heal somewhat, after which the patient may return and the temporary crown form configured for use with the sculptable anatomical healing cap may be used in chair side manufacture of a temporary provisional crown.

As shown in FIG. 7A, temporary crown form 160 may be generally configured as a “strip crown” including a body 162 shaped to provide an exterior outline of a crown of a selected tooth. Crown form 160 also includes an internal channel (e.g., configured as a hollow “straw” or as a solid “plug”) 164 bounded by a channel wall 166 that extends into the interior of the crown form 160 from body 162. Channel 164 is positioned and configured to align with hollow channel 138 of elongate body 132 of sculptable anatomical healing cap 130a. This preserves access to hollow channel 138 of healing cap 130a, preventing it from filling with dental material (e.g., an acrylic based curable composite) as a temporary crown is formed. Internal cavity 168, which is bounded by an internal surface 170 of crown body 162 and channel wall 166, is filled with dental material (e.g., initially flowable), which is allowed to cure in the case of a curable dental material.

Where the internal channel 164 is configured as a solid plug, this plug of material may insert within the open end of hollow channel 138, preventing dental material from entering therein. Where the internal channel 164 is itself hollow, the channel wall 166 may have an outside diameter that is equal to the inside diameter of hollow channel 138 of healing cap 130a so as to be engaged therein. In another embodiment, the inside diameter of channel wall 166 may be equal to an outside diameter of a cylindrical portion of elongate body 132 that extends above cuff body 144a. In either case, channel wall 166 prevents curable material being introduced into internal cavity 168 from accessing hollow channel 138 of healing cap 130a.

In one embodiment, crown body 162 further includes perforations, rouletting, or another similar weakened zone 163 (collectively referred to herein as perforations for sake of simplicity) to facilitate easy removal of the temporary crown form once a temporary crown has been formed. The perforations may be disposed along two generally opposite sides of the temporary crown body (e.g., on buccal and lingual sides, or on mesial and distal sides). The perforations 163 may run from a lower, gingival edge of the crown form towards the upper, occlusal end. They may run the entire height of the crown body 162, or only a portion thereof, as desired. In one embodiment, the perforations 163 may be present as generally parallel runs, allowing the practitioner to grip an end between parallel runs and “zip” the crown form off. Running the perforations 163 up the entire height of the crown body 162 may facilitate easier removal of the crown, as pulling at the perforated ends may effectively tear the crown form in buccal and lingual halves or mesial and distal halves. Positioning the perforations 163 along the mesial and distal sides may be preferred if they interfere with a smooth surface of the underlying finished temporary crown (as this would better hide such tell-tale marks).

FIGS. 1A-1E discussed above show the same steps to be taken when installing the sculptable anatomical healing caps of the present invention. As shown in FIGS. 1A-1E, the tooth is removed, the void 108 is prepared to receive dental implant 114, and dental implant 114 is anchored into the underlying bony tissue of the jaw bone. Rather than installing the cylindrical state of the art healing cap or cuff shown in FIG. 1F, the appropriate sculptable anatomical healing cap is selected (e.g., healing cap 130a configured for filling the emergence portion 110 of void 108 of an upper central incisor).

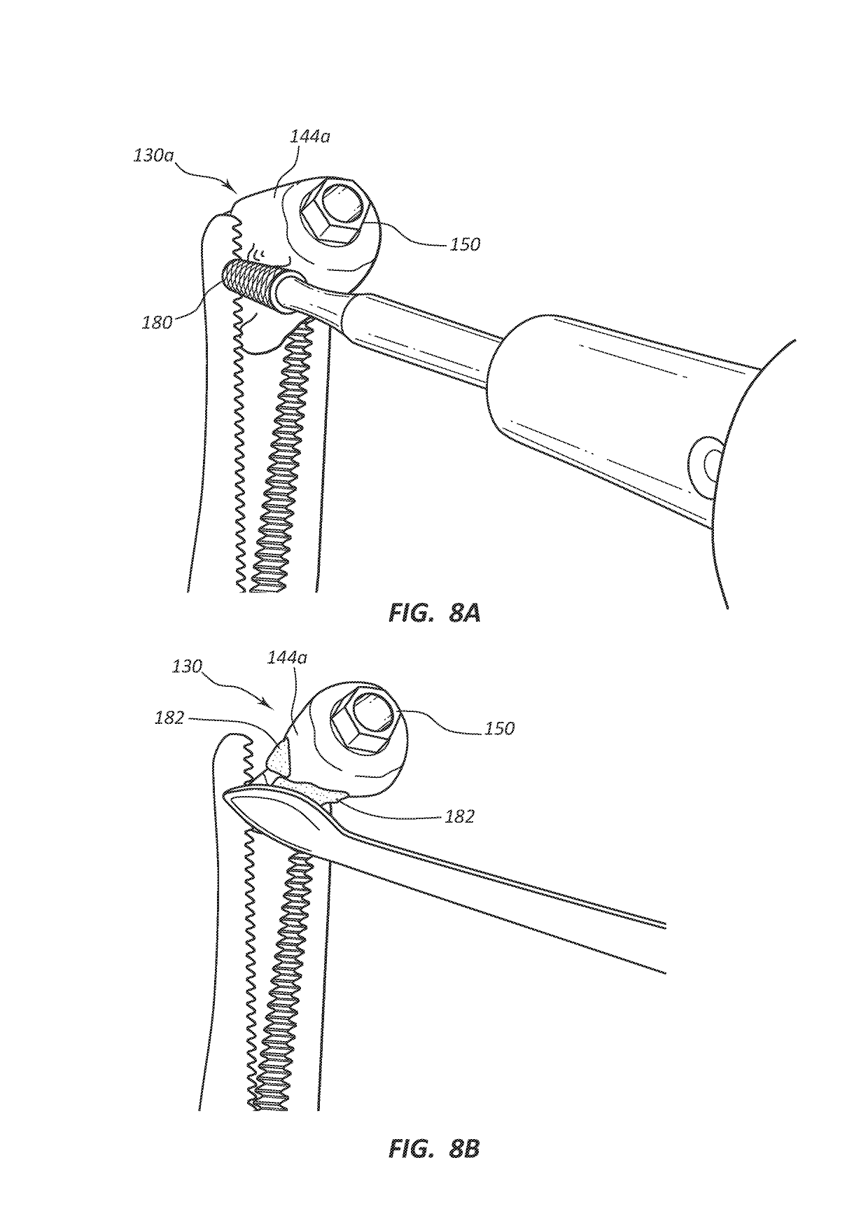

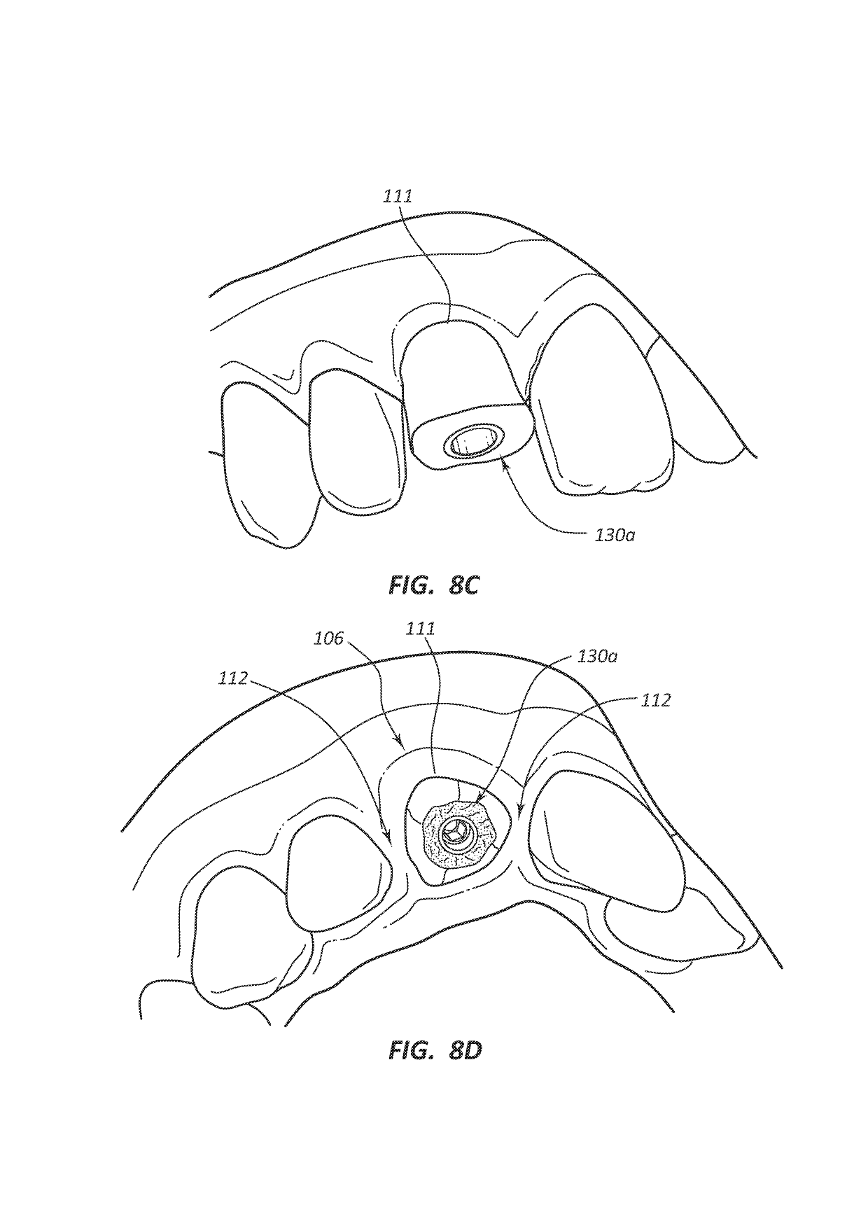

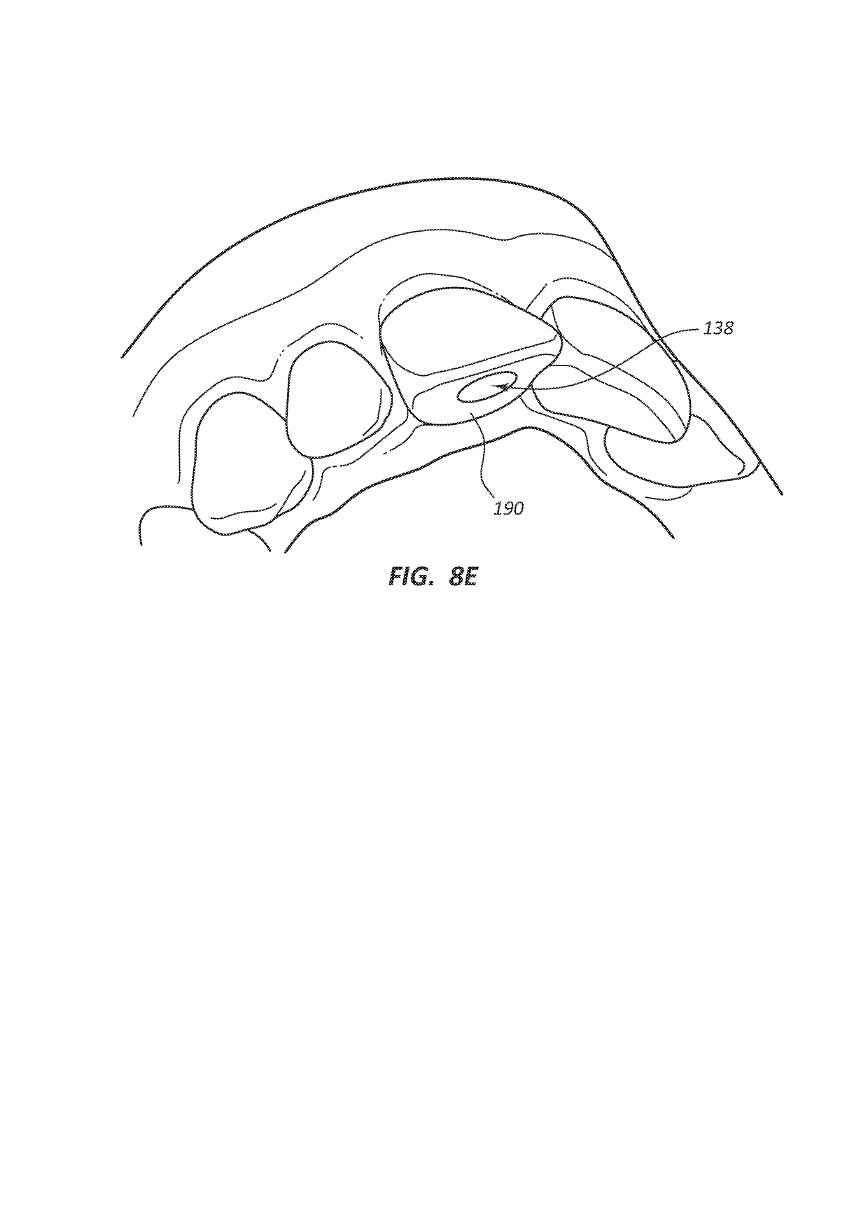

The as mass-manufactured shape and contours, which are a very close fit to the actual emergence portion 110 and emergence profile of the void 110 and tooth 102, may be custom modified as shown in FIG. 8A by removing select portions of cuff body 144a (particularly subgingival portion 146a) with a dental burr 180 or other suitable tool. As shown in FIG. 8B, if necessary, the practitioner may build up portions of cuff body 144a (particularly subgingival portion 146a) by applying and curing a dental material (e.g., light-curable, chemically-curable, heat curable, or other adhering dental material) 182. This is possible because at least the subgingival portion 146a of cuff body 144a is formed of plastic or another easily removable material, which also strongly bonds to a dental material used for build-up, so that shaving down and/or building up is easily achieved. By removing material, adding material, or both, the practitioner is advantageously able to relatively quickly customize at least the subgingival portion 146a of the cuff body 144a so that it provides a perfect or near perfect fit, filling the emergence portion 110 of void 108, with substantially no gaps.

As shown in FIG. 8C, the healing cap 130a is placed within void 108 so that subgingival portion 146a fills the emergence portion 110 with substantially no gaps, and provides an emergence profile between the gingival tissue emergence portion 110 that is substantially identical to that provided by the natural tooth prior to its removal. The exposed portion 148a resides just above the gingival tissue, which is helpful in ensuring that all gingival tissue is fully supported, particularly where there may be some small degree of variability in the contours of this gingival tissue between one patient and another for a given tooth position.

FIG. 8D shows the exposed portion 148a having been completely removed (e.g., it may be easily cut away with a burr or other convenient dental tools if desired). This view perhaps best shows how the emergence profile 111 surrounding the location where the healing cap 130a emerges from the void 108 is perfectly or nearly perfectly matched to the gingival tissue so that substantially no gaps are present (compare with the gaps that are common with state of the art healing caps shown in FIG. 1F). Because subgingival portion 146a is provided with the anatomical shape of the emergence portion 110 of void 108, the various characteristic features of gingival cuff 104 are preserved, including preservation of the full height of contour of gingival cuff 104, the interdental papilla 112, and the buccal prominence 106.

As shown in FIG. 8E, a temporary or provisional crown 190 may be chair-side formed over the sculptable anatomical healing cap 130a, while preserving access to underlying hollow channel 138 of healing cap 130a. The use of a temporary crown form 160 for this purpose is described above in conjunction with FIGS. 7A-7B. The dental material (e.g., an acrylic based composite or other curable or settable dental material) used to form temporary crown 190 may advantageously bond to upper proximal surface of exposed portion 148a of cuff body 144a during curing or setting (where the material is curable or settable), bonding the two pieces together. Temporary crown form 160 may be transparent or translucent to curing light wavelengths to allow curing of a light-curable dental composition therethrough.

When a permanent crown (typically custom prepared in an off-site dental lab) is ready for installation, the healing cap (and any temporary crown formed thereon) may simply be removed from void 108 by accessing coupling screw member 140 through hollow channel 138. The permanent crown may then be inserted within void 108, taking the place of healing cap 130a. Of course, the permanent crown may be provided with the necessary shape to fill emergence portion 110, so that the gingival tissue surrounding void 108 which has been preserved through the use of sculptable anatomical healing cap 130a can continue to be preserved.

The use of the anatomical sculptable healing cap provides for the preservation of various gingival features that are characteristic of natural teeth, including the gingival cuff, height of contour, the emergence profile, the interdental papilla, and the buccal prominence. These features are typically progressively lost over the weeks and/or months following first stage treatment where insufficient structure is provided for supporting the gingival tissue at the site where the tooth once was. Use of the present inventive healing caps, systems, and methods allow these features to be maintained, rather than progressively lost following first stage treatment and before placement of a custom permanent crown.

As used in this specification and the appended claims, the singular forms “a,” “an” and “the” include plural referents unless the context clearly dictates otherwise.

The present invention can be embodied in other specific forms without departing from its spirit or essential characteristics. Thus, the described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A chair-side customizable sculptable anatomical healing cap, comprising:
a hollow elongate body extending between a proximal end and a distal dental implant insertion end;
an enlarged cuff body extending laterally outward from the hollow elongate body disposed between the proximal end and the distal dental implant insertion end, the cuff body having an asymmetrical cross-section and an irregular surface which is configured to provide substantially custom filling of at least an emergence portion of a void where a natural tooth once emerged from the void or where a tooth would have emerged from the void;
wherein the enlarged cuff body comprises a sculptable material so that a practitioner can remove select portions of the cuff body, add to the cuff body with an adhering dental material, or both so that the enlarged cuff body can be chair-side fully customized to provide a customized fit that fills at least an emergence portion of a void where a natural tooth once emerged from the void or where a tooth would have emerged from the void.

2. The anatomical healing cap as recited in claim 1, wherein the enlarged cuff body comprises plastic.

3. The anatomical healing cap as recited in claim 1, wherein the enlarged cuff body comprises a dental composite material.

4. The anatomical healing cap as recited in claim 1, wherein the enlarged cuff body comprises a subgingival portion and a exposed portion disposed proximally relative to the subgingival portion, the subgingival portion residing within and filling an emergence portion of a void during use, while the exposed portion resides gingivally above the gingiva during use.

5. The anatomical healing cap as recited in claim 1, wherein the elongate body and the enlarged cuff body both comprise a single integral piece of plastic material.

6. The anatomical healing cap as recited in claim 1, wherein an exterior surface of the distal dental implant insertion end comprises a non-circular perimeter so as to lock against rotation once inserted within a correspondingly shaped dental implant.

7. The anatomical healing cap as recited in claim 1, wherein an exterior surface of the distal dental implant insertion end comprises a circular perimeter so as to not lock against rotation once inserted within a correspondingly shaped dental implant.

8. The anatomical healing cap as recited in claim 1, further comprising a grippable handle disposed on a buccal surface of the elongate body, the enlarged cuff body, or both.

9. A system including a temporary crown form and a chair-side customizable sculptable anatomical healing cap, the system comprising:
a customizable sculptable anatomical healing cap comprising:
a hollow elongate body extending between a proximal end and a distal dental implant insertion end;
an enlarged cuff body extending laterally outward from the hollow elongate body disposed between the proximal end and the distal dental implant insertion end, the cuff body having an asymmetrical cross-section and an irregular surface which is configured to provide substantially custom filling of at least an emergence portion of a void where a natural tooth once emerged from the void or where a tooth would have emerged from the void;
wherein the enlarged cuff body comprises a sculptable material so that a practitioner can remove select portions of the cuff body, add to the cuff body with an adhering dental material, or both so that the enlarged cuff body can be chair-side fully customized to provide a customized fit that fills at least an emergence portion of a void where a natural tooth once emerged from the void or where a tooth would have emerged from the void; and
a temporary crown form comprising:
a body shaped to provide an exterior surface outline of a crown of a selected tooth;
an internal channel bounded by a channel wall extending internally from the body of the crown form, the channel being configured to align with the hollow of the elongate body of the customizable sculptable anatomical healing cap so as to preserve access to the hollow of the healing cap when the channel is aligned with the hollow of the elongate body; and
an internal cavity bounded by an interior surface of the body of the crown form and the channel wall, the internal cavity being configured to receive a dental material while preventing the dental material from filling the channel of the crown form so as to preserve access to the hollow of the healing cap during use.

10. The system as recited in claim 9, wherein the temporary crown form further includes perforations formed into buccal and lingual sides of the body of the crown form to facilitate easy removal of the temporary crown form once a temporary crown has been formed within the internal cavity of the crown form.

11. The system as recited in claim 9, wherein the internal channel of the crown form is hollow.

12. The system as recited in claim 9, wherein the internal channel is not hollow, but comprises a plug which is insertable into the hollow of the elongate body of the sculptable anatomical healing cap.

13. A method of installing a sculptable anatomical healing cap at least partially within a void where a natural tooth once emerged from the void or where a tooth would have emerged from the void, the method comprising:
selecting a sculptable anatomical healing cap as recited in claim 1 which includes an enlarged cuff body that corresponds to a selected tooth; and
inserting the distal dental implant insertion end of the sculptable anatomical healing cap into an emergence portion of a void where a natural tooth once emerged from the void or where a tooth would have emerged from the void so that the cuff body provides a customized fit that fills at least the emergence portion of the void so as to preserve substantially all of the height of contour, the emergence profile, and the buccal prominence of the gingiva.

14. The method as recited in claim 13, further comprising removing select portions of the cuff body prior to inserting the distal dental implant insertion end into the emergence portion of the void.

15. The method as recited in claim 13, further comprising adding to the cuff body with an adhering dental material prior to inserting the distal dental implant insertion end into the emergence portion of the void.

16. The method as recited in claim 15, wherein the adhering dental material is a curable dental material.

17. The method as recited in claim 13, further comprising:
positioning a temporary crown form over the hollow elongate body, the cuff body, or both, the crown form including:
a body shaped to provide an exterior surface outline of a crown of a selected tooth;
an internal channel bounded by a channel wall extending internally from the body of the crown form, the channel being aligned with the hollow of the elongate body so as to preserve access to the hollow of the body of the healing cap; and
an internal cavity bounded by an interior surface of the crown form body and the channel wall, the internal cavity being configured to receive a dental material;
filling the internal cavity of the temporary crown form with a dental material; and
removing the temporary crown form from over the hollow elongate body so as to provide a temporary crown over the sculptable anatomical healing cap.

18. The method as recited in claim 17, wherein the internal channel is hollow.

19. The method as recited in claim 17, wherein the internal channel is not hollow, but comprises a plug which is insertable into the hollow of the elongate body of the sculptable anatomical healing cap.

20. The method as recited in claim 17, wherein the temporary crown form further includes perforations formed into buccal and lingual sides of the body of the crown form, removing the temporary crown form comprising tearing of the temporary crown form body along the perforations.

21. The method as recited in claim 17, wherein the dental material introduced into the internal cavity of the temporary crown form is a curable dental material, the method further comprising curing the curable dental material before removing the temporary crown form from over the hollow elongate body.
